(19) United States
(12) Patent Application Publication
(10) Pub. No.: US 2009/0229098 A1
(43) Pub. Date: Sep. 17, 2009

(54) Piston ring installation

(76) Inventor: Jeff Esterly, Elgin, IL (US)

Correspondence Address: JEFF ESTERLY, 3016 CRANSTON AVENUE, ELGIN, IL, 60123, US

(21) Appl. No.: 12/075,876

(22) Filed: Mar. 14, 2008

(51) Int. Cl. B23P 15/06

(52) U.S. Cl. 29/222

(57) ABSTRACT

A tool for preparing piston rings for installation on a piston to be mounted in a bore includes a first cylindrical bore section having an inner diameter equal in measurement to an inner diameter of the cylinder in which the piston is to be mounted. A second cylindrical bore section has an inner diameter smaller in measurement to an inner diameter of the cylinder in which the piston is to be mounted, and the second cylindrical bore section is coaxial with the first cylindrical bore section. A squaring shoulder separates the first cylindrical bore section from the second cylindrical bore section, the squaring shoulder being oriented perpendicular to the axis of the bore sections. The first cylindrical bore section is adapted and constructed to receive piston rings to be mounted on the piston within the cylinder so that the rings are inserted and removed in the shaping process, thus preventing damage from insertion and removal into the cylinder itself.

### CROSS-REFERENCE TO RELATED APPLICATION

None

### BACKGROUND OF THE INVENTION

The present invention relates generally to internal combustion engines, and specifically to the installation of piston rings of such engines.

### DESCRIPTION OF RELATED ART

An internal combustion engine is any engine that uses the explosive combustion of fuel to push a piston within a cylinder—the piston's movement turns a crankshaft that then turns the car wheels via a chain or a drive shaft. The different types of fuel commonly used for car combustion engines are gasoline (or petrol), diesel, and kerosene. The internal combustion engine was conceived in 1680 by the Dutch physicist, Christian Huygens. His design was never built, and was to be fueled with gunpowder. In 1807, Francois Isaac de Rivaz of Switzerland invented an internal combustion engine that used a mixture of hydrogen and oxygen for fuel. Rivaz designed a car for his engine—the first internal combustion powered automobile.

One of the most important landmarks in engine design comes from Nicolaus August Otto who in 1876 invented an effective gas motor engine. Otto built the first practical four-stroke internal combustion engine called the “Otto Cycle Engine,” and as soon as he had completed his engine, he built it into a motorcycle. Otto's contributions were very historically significant, it was his four-stoke engine that was universally adopted for all liquid-fueled automobiles going forward.

In 1885, Gottlieb Daimler invented what is often recognized as the prototype of the modern gas engine. Patented in 1887, the Daimler engine included a vertical cylinder, and with gasoline injected through a carburetor. Daimler first built a two-wheeled vehicle the “Reitwagen” (Riding Carriage) with this engine and a year later built the world's first four-wheeled motor vehicle. Gottlieb Daimler (together with his design partner Wilhelm Maybach) took Otto's internal combustion engine a step further and patented what is generally recognized as the prototype of the modern gas engine. Daimler's connection to Otto was a direct one; Daimler worked as technical director of Deutz Gasmotorenfabrik, which Nikolaus Otto co-owned in 1872.

The 1885 Daimler-Maybach engine was small, lightweight, fast, used a gasoline-injected carburetor, and had a vertical cylinder. The size, speed, and efficiency of the engine allowed for a revolution in car design. On Mar. 8, 1886, Daimler took a stagecoach and adapted it to hold his engine, thereby designing the world's first four-wheeled automobile. Daimler is considered the first inventor to have invented a practical internal-combustion engine.

Through the ensuing decades, the quest for faster, more efficient, and more powerful automobiles has driven development on almost every conceivable level. Among these is the optimization of the size, materials, and configurations of pistons and cylinders. In many instances, including those in which cylinders are bored out to increase the displacement of the engine, it is often necessary to replace the piston rings surrounding the outer peripheral surface of the piston, and providing the interface between the piston and the interior wall of the cylinder.

Piston rings are installed in a manner to minimize cylinder leakage and maximum durability. Piston rings are provided in a variety of materials, including moly filled, chrome and steel. A piston-ring squaring tool, such as that manufactured by Childs and Albert, is used to install the ring in the appropriate bore. This process involves placing each ring at the mouth of the bore, then using the squaring tool to force the ring iinto position. A feeler gauge is used to determine the fit of the ring within the cylinder. If adjustment of the ring is required, the ring is removed from the bore, and a file or other similar device is used to re-shape the ring. This process is repeated until the ring fits to the satisfaction of the technician. Subsequently, the rings are mounted onto the piston, and the piston is mounted in the cylinder bore.

Various devices for assisting in this process have been developed, and are represented in the patent literature. For example, U.S. Pat. No. 7,096,553 to Carruth is directed to device, adapted to position a ring in the bore of a cylinder so that the ring is perpendicular to the axis of the cylinder, including a first segment and a second segment. The first segment has a tongue which is slidably received in a groove in the second segment. A threaded shaft of a hand screw is received through the groove and into a threaded aperture in the tongue to attach the first segment to the second segment. Arcuate surfaces and of the first and second segments, respectively, define a portion of the circumference of a circle approximately the diameter of the bore when the segments are attached to each other. The ring is positioned in the bore and the device is inserted in the bore until the lip of the first and second segments rest on the top edge of the cylinder. The bottom of the surfaces thus push against the ring, and because the surfaces are the same height, the ring is positioned perpendicularly to the axis of the cylinder so that the gap between the ends of the ring can be accurately measured.

U.S. Pat. No. 6,421,930 to Foster deals with a piston ring locating system including a resilient ring fabricated in a generally circular configuration having a short height and a length of between about 2 inches and 5 inches with overlapping free ends. One of the ends has a slight bend there adjacent for fitting inside the opposite end. The rings are outwardly biased resiliently to allow varying the circumference of the ring as a function of the cylinder in which it is to be placed. The ring thus forms an interior surface and an exterior surface positionable within the cylinder in which it is to be placed. The ring has a top edge and a bottom edge constituting an abutment surface. Projection means extends outwardly from the exterior surface to a short distance and is adapted to be located on the upper edge of the block of the cylinder with which it is to be utilized.

U.S. Pat. No. 5,979,071 to Kim involves a piston ring gap measuring device for a vehicle includes a master bore having a guide slit on one side and a thickness gauge on the other side. A tolerance scale is provided adjacent to the guide slit and corresponds to tolerance thicknesses of the thickness gauge. A piston ring may be placed onto a ring supporting disk and moved downwardly into the master bore until the piston ring gap encounters a part of the thickness gauge having a thickness dimension greater than the gap thickness. The gap thickness can be obtained from the tolerance scale. The ring supporting disk includes guide tabs movable within grooves in the master bore, and the ring supporting disk is biased upwardly.

U.S. Pat. No. 5,038,449 to Huggins shows a tool for use in checking and filing the end gap of piston rings. The tool includes a cylindrical member having a shoulder adjacent one end thereof which will receive and seat a piston ring and position it at a predetermined depth below the deck of a bore in order to determine the end gap between the adjacent ends of a piston ring with the shoulder on the tool providing for accurate position of the piston ring at a given depth throughout the 360.degree. circle of the piston ring. The tool includes a groove or channel formed therein by which the end gap can be filed to increase the end gap to the desired dimension. The tool enables the ring to be positioned in the cylinder and the end gap measured and the tool then is used to hold the ring when filing the ends. The slot or groove in the tool provides a guide for the file when filing the end gap.

U.S. Pat. No. 2,648,136 to Lanigan shows a piston ring fitting device providing a split sleeve adapted to be fitted within a cylinder, to push a piston ring down into the cylinder, and having stop means for positively limiting the downward shifting movement of the sleeve and ring within the cylinder.

Although the arrangements described in these patents provide certain advantages, they present certain deficiencies as well. All of these devices require repeated removal and re-insertion of the rings into the bore in the ring fitting process. This frequently results in damage to the surface of the bore, or in coatings provided thereon. Further, many of these devices are relatively complicated and difficult to implement. It can thus be seen that the need exists for a simple, efficient, and easily implemented arrangement for adapting piston rings for installation.

### SUMMARY OF THE INVENTION

According to one aspect of the invention, a tool for preparing piston rings for installation on a piston to be mounted in a bore includes a first cylindrical bore section having an inner diameter equal in measurement to an inner diameter of the cylinder in which the piston is to be mounted. A second cylindrical bore section has an inner diameter smaller in measurement to an inner diameter of the cylinder in which the piston is to be mounted, and the second cylindrical bore section is coaxial with the first cylindrical bore section. A squaring shoulder separates the first cylindrical bore section from the second cylindrical bore section, the squaring shoulder being oriented perpendicular to the axis of the bore sections. The first cylindrical bore section is adapted and constructed to receive piston rings to be mounted on the piston within the cylinder so that the rings are inserted and removed in the shaping process, thus preventing damage from insertion and removal into the cylinder itself.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Embodiments of the invention are illustrated by way of example, and not by way of limitation, in the figures of the accompanying drawings and in which like reference numerals refer to similar elements and in which:

FIG. 1 illustrates a perspective view of an embodiment of a tool in accordance with the principles of the present invention;

FIG. 2 illustrates a sectional view taken generally along lines II-II of FIG. 1;

FIG. 3 illustrates a sectional view of an another embodiment of a tool in accordance with the principles of the present invention.

### DETAILED DESCRIPTION OF THE INVENTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows, will refer to the invention as depicted in the drawing.

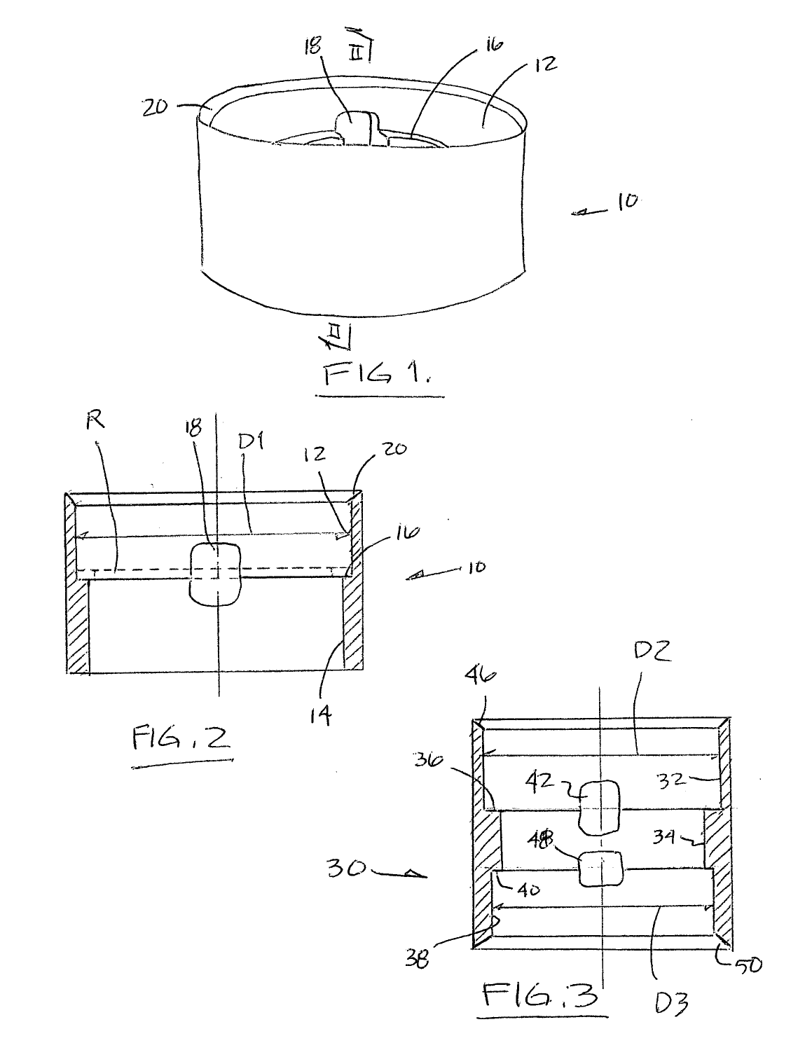

According to one embodiment shown in FIGS. 1 and 2, a tool 10 for preparing piston rings for installation on a piston to be mounted in a bore is provided. The tool 10 includes a first cylindrical bore section 12 having an inner diameter D1 equal in measurement to an inner diameter of the cylinder in which the piston is to be mounted. A second cylindrical bore section 14 has an inner diameter smaller in measurement to an inner diameter of the cylinder in which the piston is to be mounted. The second cylindrical bore section 14 is coaxial with the first cylindrical bore section 12. A squaring shoulder 16 separates the first cylindrical bore section 12 from the second cylindrical bore section 14. The squaring shoulder 16 is oriented perpendicular to the axis of the cylindrical bore sections 12, 14. The tool 10 can be fabricated from any suitable material. It is contemplated that a metal, such as anodized aluminum or steel, will suffice.

An access aperture 18 extends through the first cylindrical bore section 12, the second cylindrical bore section 14, and the squaring shoulder 16. A chamfered insertion edge 20 on the first cylindrical bore section 12.

In use, piston rings R to be mounted on the piston within the cylinder are inserted into the tool 10, squared against the squaring shoulder 16. A feeler gauge is used, through the access aperture 18, to assess the fit of the ring R. The ring R is then removed and its contour adjusted, then the ring is re-inserted into the tool 10, squared, and gauged again. This process of removal, adjustment, re-insertion, and measurement is repeated until the ring fits satisfactorily. When the adjustment process is completed, the ring is installed on the piston.

It is contemplated that the tool 10 can be provided to correspond to commonly-used cylinder bore sizes, such as 4.00 inches (with a 3.990 inch second section) or 4.060 inches (with a 4.050 inch second section). Separate tools can be provided for each desired bore size. Alternatively, multiple bore sizes can be accommodated within a single tool 30, as shown in FIG. 3. The tool 30 includes a first cylindrical bore section 32 having an inner diameter D2 equal in measurement to an inner diameter of a first cylinder in which a first piston is to be mounted. A second cylindrical bore section 34 has an inner diameter smaller in measurement to an inner diameter of the cylinder in which the piston is to be mounted. The second cylindrical bore section 34 is coaxial with the first cylindrical bore section 32. A first squaring shoulder 36 separates the first cylindrical bore section 32 from the second cylindrical bore section 34. The squaring shoulder 36 is oriented perpendicular to the axis of the cylindrical bore sections 32, 34. A third cylindrical bore section 38 having an inner diameter D3 equal in measurement to an inner diameter of a second, different sized cylinder in which a piston is to be mounted. The third cylindrical bore section 38 is coaxial with the first and second cylindrical bore sections 32, 34. A second squaring shoulder 40 separates the third cylindrical bore section 38 from the second cylindrical bore section 34. The second squaring shoulder 40 is oriented perpendicular to the axis of the cylindrical bore sections 32, 34, 38. The tool 30 can be fabricated from any suitable material. It is contemplated that a metal, such as anodized aluminum or steel, will suffice.

A first access aperture 44 extends through the first cylindrical bore section 32, the second cylindrical bore section 34, and the first squaring shoulder 36. A first chamfered insertion edge 46 is provided on the first cylindrical bore section 12. A second aperture 48 extends through the third cylindrical bore section 38, the second cylindrical bore section 34, and the second squaring shoulder 40. A second chamfered insertion edge 50 is provided on the third cylindrical bore section 38.

Piston rings to be mounted on the piston within the cylinders are inserted into, squared, and removed from each end of the tool 30 in the manner described with reference to tool 10 of FIGS. 1 and 2. This process of removal, adjustment, re-insertion, and measurement is repeated until the ring fits satisfactorily. When the adjustment process is completed, the ring is installed on the piston.

It can thus be seen that the cylinder of the engine in which the pistons are to be mounted is spared any potential damage incurred with repeated insertion and removal of the rings during the fitting process.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. A tool for preparing piston rings for installation on a piston to be mounted in a bore, the tool comprising the following:
a first cylindrical bore section having an inner diameter equal in measurement to an inner diameter of the cylinder in which the piston is to be mounted;
a second cylindrical bore section having an inner diameter smaller in measurement to an inner diameter of the cylinder in which the piston is to be mounted, the second cylindrical bore section being coaxial with the first cylindrical bore section; and
a squaring shoulder separating the first cylindrical bore section from the second cylindrical bore section, the squaring shoulder being oriented perpendicular to the axis of the bore sections;
whereby the first cylindrical bore section is adapted and constructed to receive piston rings to be mounted on the piston within the cylinder so that the rings are inserted and removed in the shaping process, thus preventing damage from insertion and removal into the cylinder itself.

2. A tool in accordance with claim 1, further comprising an aperture extending through the tool, the aperture being adapted and constructed to accomodate the use of a feeler gauge to determine the ring gap.

3. A tool in accordance with claim 2, wherein the aperture extends through the first cylindrical bore section.

4. A tool in accordance with claim 3, wherein the aperture extends through the first cylindrical bore section, the second cylindrical bore section, and the squaring shoulder.

5. A tool in accordance with claim 1, further comprising a chamfered insertion edge on the first cylindrical bore section.

6. A tool in accordance with claim 1, wherein the tool is fabricated from metal.

7. A tool in accordance with claim 6, wherein the tool is fabricated from aluminum.

8. A tool in accordance with claim 7, wherein the tool is fabricated from anodized aluminum.

9. A tool for preparing piston rings for installation on a piston to be mounted in a bore, the tool comprising the following:
a first cylindrical bore section having an inner diameter equal in measurement to an inner diameter of a first cylinder in which a first piston is to be mounted;
a second cylindrical bore section having an inner diameter smaller in measurement to an inner diameter of the cylinder in which the piston is to be mounted, the second cylindrical bore section being coaxial with the first cylindrical bore section;
a first squaring shoulder separating the first cylindrical bore section from the second cylindrical bore section, the first squaring shoulder being oriented perpendicular to the axis of the bore sections;
a third cylindrical bore section having an inner diameter equal in measurement to an inner diameter of a second cylinder in which a second piston is to be mounted, the third cylindrical bore section being coaxial with the first cylindrical bore section and the second cylindrical bore section;
a second squaring shoulder separating the third cylindrical bore section from the second cylindrical bore section, the second squaring shoulder being oriented perpendicular to the axis of the bore sections;
whereby the first and third cylindrical bore sections are adapted and constructed to receive piston rings to be mounted on the respective pistons within the respective cylinders so that the rings are inserted and removed into the tool in the shaping process, thus preventing damage from insertion and removal into the cylinder itself.

10. A tool in accordance with claim 9, further comprising at least one aperture extending through the tool, the aperture being adapted and constructed to accommodate the use of a feeler gauge to determine the ring gap.

11. A tool in accordance with claim 10, wherein the at least one aperture comprises a plurality of apertures.

12. A tool in accordance with claim 11, wherein the plurality of apertures includes a first aperture extending through the first cylindrical bore section, and a second aperture extending through the third cylindrical bore section.

13. A tool in accordance with claim 12, wherein the first aperture extends through the first cylindrical bore section, the second cylindrical bore section, and the first the squaring shoulder.

14. A tool in accordance with claim 13, wherein the second aperture extends through the third cylindrical bore section, the second cylindrical bore section, and the second the squaring shoulder.

15. A tool in accordance with claim 9, further comprising a first chamfered insertion edge on the first cylindrical bore section.

16. A tool in accordance with claim, further comprising a second chamfered insertion edge on the third cylindrical bore section.

17. A tool in accordance with claim 9, wherein the tool is fabricated from metal.

18. A tool in accordance with claim 17, wherein the tool is fabricated from aluminum.

19. A tool in accordance with claim 18, wherein the tool is fabricated from anodized aluminum.
